(19) United States
(12) Patent Application Publication
(10) Pub. No.: US 2020/0104899 A1
(43) Pub. Date: Apr. 2, 2020

(54) SYSTEMS AND METHODS FOR AUTOMATED PREDICTIVE PRODUCT PROCUREMENT

(71) Applicant: Rovi Guides, Inc., San Jose, CA (US)

(72) Inventors: Abhishek Banerjee, Natick, MA (US); Abhijeet Sharma, Somerville, MA (US)

(21) Appl. No.: 16/146,735

(22) Filed: Sep. 28, 2018

(51) Int. Cl. G06Q 30/06; G06Q 30/02; H04W 4/029; H04W 4/35

(52) U.S. Cl. CPC G06Q 30/0631; G06Q 30/0633; H04W 4/35; H04W 4/029; G06Q 30/0205

(57) ABSTRACT

The disclosure relates to a system that detects customers traveling to a merchant site, predicts products they are interested in purchasing at that merchant site, and collects those products at the merchant site for purchase before the customer arrives. Prediction of products is accomplished by comparing a consumer profile to the products carried at the merchant site. Matching products are transmitted to the merchant site, which then collects the products together as a completed order for the consumer to simply pick up as soon as he or she enters the store. In this manner, customers receive the products they likely want without having to spend the time and effort of manually collecting each product themselves.

### BACKGROUND

This disclosure relates generally to prediction systems, and more specifically to automated predictive product procurement.

### SUMMARY

Current consumer shopping options suffer from notable deficiencies. Traditional shopping at physical “brick and mortar” stores requires not only the time spent traveling to and from a store, but perhaps more significantly requires physically selecting and trying out many different items before deciding on a purchase. This process is often laborious and time consuming, leading to excessively long and sometimes frustrating shopping sessions.

Online shopping, while touted as a cure for such ills, also falls short. While the selection and number of products available online may (or may not) be greater than at any individual brick and mortar store, online shopping does not allow shoppers to actually see or try out any products before purchase. The risk of getting the wrong product, or simply one that was not quite what the consumer was looking for, is much greater.

Accordingly, to overcome the deficiencies that exist when shopping both online and physically in stores, systems and methods are described herein for a computer-based process that predicts when a customer is likely headed to a store, and what he or she is likely going to purchase at that store. The likely products for purchase are communicated to the store before the consumer arrives, whereupon the store collects the products for the consumer ahead of his or her arrival in the store. In this manner, consumers' shopping needs are predicted ahead of their arrival at a store, and transmitted to the store so that the predicted goods are assembled and ready by the time consumers arrive. This saves consumers from having to physically select and try out items before deciding on what to purchase, and as products are predicted, perhaps from the consumer's shopping history or preference profile, the risk of getting the wrong product is decreased.

In more detail, a computer-based system detects when a consumer is likely traveling to a store or merchant site. When a consumer is determined to be traveling to a merchant site, the system retrieves a shopping profile specific to the user, and compares it to the items offered for sale at that particular store. The user profile may be used to determine items the consumer is likely intending to purchase at the store he or she is headed to. Any such items that are carried by the store are compiled into a list which is transmitted to the merchant site. Upon receiving this list, the store collects the items from its inventory on hand, so that they are ready for the consumer to inspect and purchase immediately upon his or her entry into the store. As above, this provides the customer the benefit and convenience of instantly available products that are also more likely to be the products the customer is seeking.

Determining that the consumer is likely traveling to a particular store is accomplished in any of a number of ways described below. For instance, the system can monitor or otherwise receive an address the consumer enters into a navigation application on his or her mobile device. When this address matches a known merchant site, it may be deemed that the consumer is intending to travel soon to that merchant site. As another example, the movement of the consumer's mobile device may be tracked, such as by a global positioning system (GPS) application on that mobile device. When that movement indicates that the consumer is likely headed to a particular site, such as when a GPS-determined path of the consumer appears to be likely leading to a merchant site, the consumer may be assumed to be traveling to that particular store. As an additional example, the system can examine search terms entered into a search engine application of the consumer's mobile device. These terms may indicate that the consumer is likely planning to travel to a merchant, perhaps as evidenced by multiple searches for a particular item sold by that merchant, where the search terms are all entered within a specified time frame.

Similarly, determining items the consumer is likely intending to purchase may also be accomplished in a number of ways. Product types likely to be purchased may be determined from a user profile, for example, where specific products likely to be purchased may be any products offered or stocked by the merchant that are of those product types. That is, user profiles may describe certain categories of products likely to be purchased, and any merchant products falling within those categories may be deemed likely to be purchased. For example, if a user profile shows a pattern of buying a particular type of product every month, e.g. a type of cleaning product, and the user is headed to a store offering that product having not yet bought that type of product this month, cleaning products of that type and offered by the merchant may be deemed as likely to be purchased by that consumer, and collected for his or her purchase.

Accordingly, consumer purchase histories may thus be employed as one approach for determining likely purchases. In addition to the above, purchase histories recorded in a user profile may be extrapolated to indicate likely current purchases. In similar manner, frequently searched items may also be used to determine likely purchases. For instance, many recent searches for a particular item may indicate keen interest in purchasing that item, so that when a consumer is headed to a store, it is likely that he or she is heading there to purchase said item.

The shopping profile can be any electronic profile of a particular consumer, and may contain any information relevant to the consumer and his or her purchases. For instance, the profile may contain one or more unique identifiers allowing customer orders to be associated with a particular individual, as well as a purchase history, preferred items, history of stores visited, and the like. The profile can be compiled in any manner, such as by electronic records of past purchases, detection of purchased products or product needs by sensors placed in the consumer's environment such as internet of things (IoT) sensors, or in any other manner.

The various features described above can be employed in any combination, and utilized in any embodiment. For example, likely purchases can be determined by some combination of purchase history and frequently searched items. Likewise, whether a consumer is headed to a particular site can be determined in any manner, such as a combination of determined route and history of stores visited.

### BRIEF DESCRIPTION OF THE FIGURES

The above and other objects and advantages of the disclosure will be apparent upon consideration of the following detailed description, taken in conjunction with the accompanying drawings, in which like reference characters refer to like parts throughout, and in which:

FIG. 1 illustrates operation of an exemplary automatic predictive product procurement system constructed according to embodiments of the disclosure;

FIG. 2 is a block diagram representation of an exemplary automatic predictive product procurement system constructed according to embodiments of the disclosure;

FIG. 3 is a generalized embodiment of an electronic computer constructed to implement predictive product procurement operations of embodiments of the disclosure; and

FIG. 4 is a flowchart illustrating process steps of predictive product procurement according to embodiments of the disclosure.

### DETAILED DESCRIPTION

In one embodiment, the disclosure relates to a system that detects customers traveling to a merchant site, predicts products they are interested in purchasing at that merchant site, and collects those products at the merchant site for purchase before the customer arrives. Prediction of products is accomplished by comparing a consumer profile to the products carried at the merchant site. Matching products are transmitted to the merchant site, which then collects the products together as a completed order for the consumer to simply pick up as soon as he or she enters the store. In this manner, customers receive the products they likely want without having to spend the time and effort of manually collecting each product themselves.

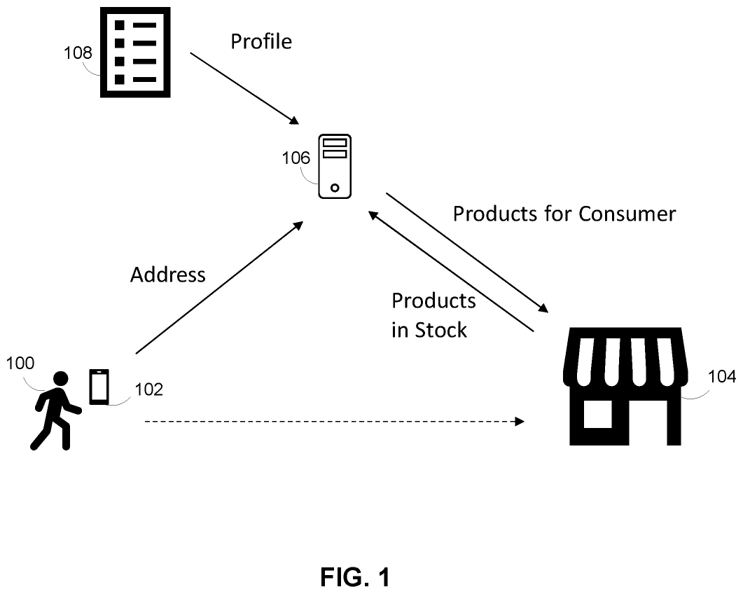

FIG. 1 illustrates operation of an exemplary automatic predictive product procurement system constructed according to embodiments of the disclosure. A user 100 has a mobile communication device 102 that communicates with a prediction computer 106. Prediction computer 106 is able to access user profiles 108, including a profile of user 100. User 100 is headed to a merchant site 104 to purchase items.

The prediction computer 106 determines that the user 100 and device 102 are headed to merchant site 104. When this determination is made, the prediction computer 106 retrieves a profile 108 of user 100 from another computer or an electronic storage. The profile 108 is a shopping profile of the user, and contains information such as a purchase history of the user. The prediction computer also retrieves, from the merchant site 104 or another source, information on the products available for purchase at the merchant site 104. The prediction computer 106 uses the information of the profile 108 to predict products that the user 100 is likely intending to purchase at the merchant site 104, and determines products carried by the merchant site 104 that may correspond to these intended products. That is, the prediction computer 106 determines what products the user 100 wants, and what products of merchant site 104 satisfy these wants. The prediction computer 106 then transmits these predicted products to the merchant site 104, which assembles the products together for the user 100 to purchase. In an embodiment, the prediction computer 106 transmits these predicted products to the merchant site 104 in time for the products to be retrieved and presented to the user 100 as soon as he or she enters the merchant site 104.

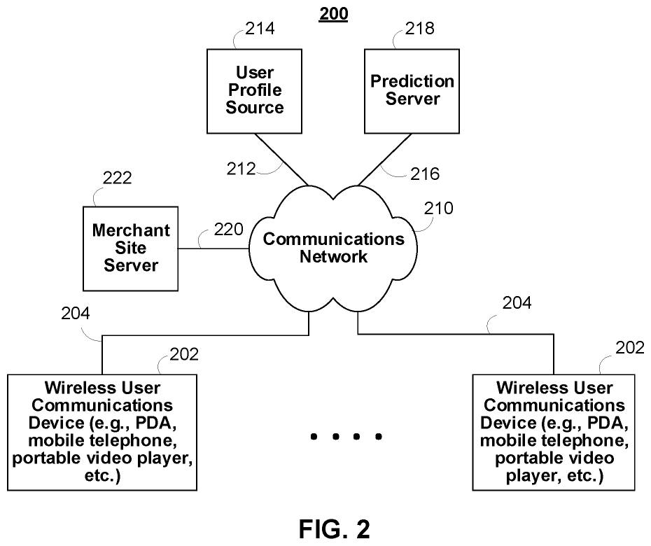

FIG. 2 is a block diagram representation of the system shown in FIG. 1. Here, system 200 includes a number of wireless user communications devices 202 which are in electronic communication with prediction server 218 across communication paths 204 and 216, through communications network 210. Communications network 210 may be one or more networks including the Internet, a mobile phone network, mobile voice or data network (e.g., a 4G or LTE network), cable network, public switched telephone network, or other type of communications network or combinations of communications networks. Paths 204 and 216 may separately or together include one or more communications paths, such as, a satellite path, a fiber-optic path, a cable path, a path that supports Internet communications, free-space connections (e.g., for broadcast or other wireless signals), or any other suitable wired or wireless communications path or combination of such paths. These paths may be wireless paths if desired. Communications with the user equipment devices may be provided by one or more of these communications paths, but are shown as a single path in FIG. 2 to avoid overcomplicating the drawing.

Prediction server 218 is in electronic communication with a user profile source 214 via communications path 212 and communications network 210. Server 218 is also in electronic communication with merchant site server 222 via communications path 220 and communications network 210. Paths 212 and 220 may be similar in nature to previously described paths 204 and 216.

System 200 may include any number of communications devices 202, each employed by a user such as user 100. Device 102 may correspond to one of the communications devices 202. Each device 202 is shown as a wireless user communications device, such as a cellular or mobile telephone, smart phone, personal digital assistant (PDA), or any other portable electronic communications device. In one embodiment, devices 202 are smart phones that communicate with prediction server 218 over paths 204 and 216 as well as communications network 210, and that also perform various functions such as conducting electronic searches by running a search application, determining location via, e.g., a global positioning system (GPS) application, and the like. Such smart phone capabilities are known. Each device 202 may also be any other type of electronic computing device, such as a laptop computer, desktop computer, or the like.

The prediction server 218 and merchant site server 222 may be server computers configured in any manner. In one embodiment, the prediction server 218 may be a cloud server, and the merchant site server 222 may be a server located at the merchant site 104. Alternatively, the merchant site server 222 may also be a cloud server in communication with a networked computer (not shown) located at the merchant site 104. In yet another embodiment, the prediction server 218 and merchant site server 222 may be the same computer, and may be a cloud server or a server located at merchant site 104. The servers 218 and 222 may be any computers configured in any manner to carry out the processes of the present disclosure.

The user profile source 214 includes an electronic memory storing user profiles, and may be any computing device that allows access to user profiles via communication path 212. In one embodiment, the user profile source 214 is a computer located at a residence of user 100 and storing a personal profile of user 100. The profile may be built by an application residing on source 214. User profiles and their construction are known, and embodiments of the disclosure contemplate use of any type of user profile containing any type of user information that can be used to predict products the user may want. In another embodiment, the user profile source 214 resides on prediction server 218. In this embodiment, the prediction server 218 may build and maintain user profiles itself, rather than relying on individual users 100 to construct their own profiles. Any type of user profile, stored in any storage, is contemplated for use by the various embodiments of the disclosure.

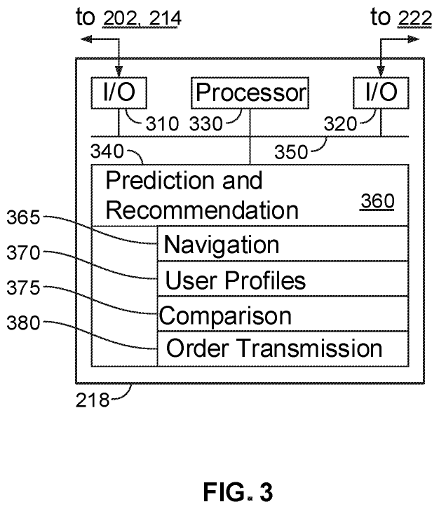

Prediction server 218 may be an embodiment of prediction computer 106. FIG. 3 illustrates further details of the construction of prediction server 218. Here, server 218 is an electronic computer that has input/output (I/O) modules 310 and 320 for transferring data to and from user communications devices 202 and merchant site server 222 respectively. The server 218 also has a processor 330 and memory 340. The I/O modules 310 and 320, processor 330, and memory 340 are each connected to, and communicate with each other through, a bus 350. The processor 330 and memory 340 may collectively be considered as control circuitry.

The processor 330 executes programs stored in memory 340, including a prediction and recommendation program 360 with a number of modules or routines. The modules include a navigation module 365, user profiles 370, comparison module 375, and order transmission 380.

The navigation module 365 determines when a user 100 is headed to a merchant site 104. User profiles 370 are local storage for profiles retrieved from user profile source 214 or determined by prediction and recommendation program 360. Comparison module 375 retrieves product information from merchant site server 222, and compares user profiles 370 to this product information to determine products the user 100 is likely intending to purchase at merchant site 104. Order transmission module 380 receives products determined by comparison module 375, and transmits them to the merchant site server 222 via I/O 320.

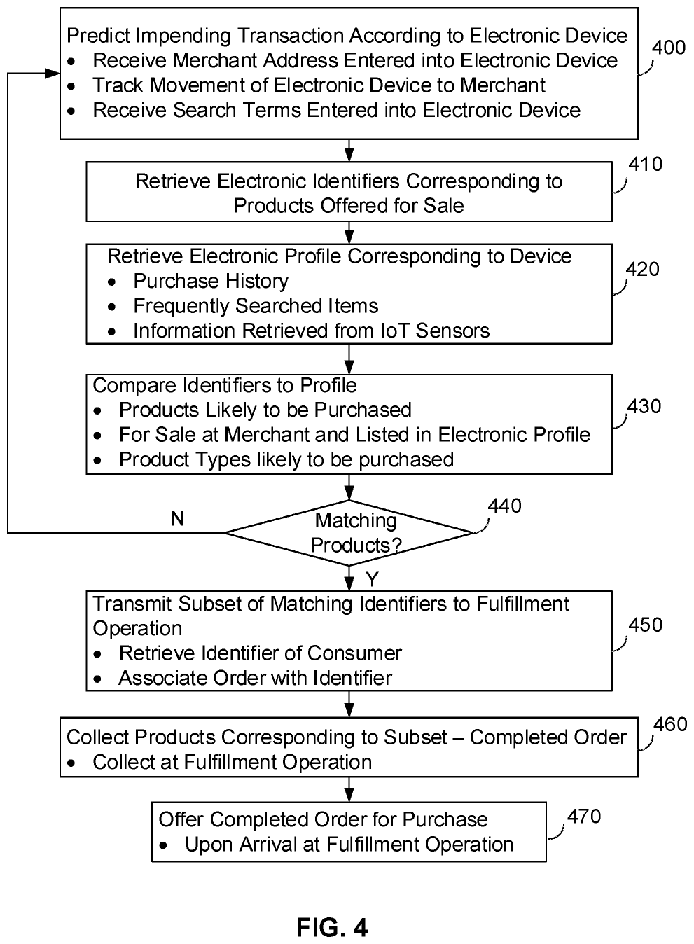

In operation, prediction server 218 estimates when users 100 are traveling to merchant site 104, retrieves corresponding user profiles 370 and product information from merchant site server 222, and compares the two to determine products the users 100 are likely intending to purchase. The server 218 then transmits these products to merchant site server 222 as an order to be fulfilled. FIG. 4 is a flowchart illustrating further details of this process.

The process of FIG. 4 begins when the navigation module 365 predicts the occurrence of an impending transaction (Step 400). This is accomplished by detecting a consumer, i.e. a particular device 102, traveling to merchant site 104. Detection of travel, and thus prediction of an impending transaction, can be determined in any manner. In one example, the navigation module 365 polls the mobile communication device 102 of user 100 for, or otherwise receives, addresses entered into a maps application or other navigation application running on device 102. An address entered into a map or other navigation application may be deemed as an indication that the user 100 is likely traveling to that address. Thus, when the navigation module 365 detects an address entered into a particular device 102 and matching the address of the merchant site 104, it may determine that the user 100 corresponding to device 102 is likely traveling to the merchant site 104 soon.

In another example, the navigation module 365 tracks the movement of consumer device 102 to determine whether it is headed to the merchant site 104. In particular, the navigation module 365 polls the mobile communication device 102 for, or otherwise receives, location information of device 102. Location information may be determined from a GPS application running on device 102 for instance, although any method of determining a location, however precise, of device 102 may be employed. One or more locations near the merchant site 104 may be sufficient to determine that the user 100 is headed to merchant site 104. Alternatively, multiple locations over a period of time may also be used to determine a path or route that the user 100 is traversing. When this path appears to lead to the merchant site 104, the navigation module 365 may determine that the merchant site 104 is the likely destination of the user 100.

As yet another example, the navigation module 365 polls the mobile communication device 102 for, or otherwise receives, terms entered into an electronic search application running on device 102. Such search terms may be deemed as likely indicating that the user 100 will soon be headed to the merchant site 104. For instance, the entry of the name of the merchant along with the entry of specific products sold by merchant site 104 may indicate that user 100 is interested in a specific product sold at merchant site 104. Likewise, the entry of multiple specific products sold at merchant site 104, or a query concerning hours of operation for merchant site 104, multiple queries about merchant site 104 or its products within a predetermined time period, or the like may indicate strong interest in purchasing products at that particular merchant. Embodiments of the disclosure contemplate use of any one or more search terms to determine that a user 100 is likely traveling to a merchant site 104 to purchase products.

As above, any information may be employed by navigation module 365 to estimate that a user 100 is likely headed to merchant site 104. Embodiments of the disclosure also employ any combination of any of the above information. For example, navigation module 365 may determine that a user 100 is likely headed to the merchant site 104 when it receives information indicating that the user 100 has entered the address of merchant site 104 into device 102, and is proceeding along a route that appears directed at the merchant site 104. Similarly, navigation module 365 may make the same determination when it detects search terms corresponding to products carried at merchant site 104, along with a user location near merchant site 104.

Once the consumer is detected as traveling to merchant site 104, the prediction and recommendation engine 360 retrieves electronic identifiers corresponding to products offered for sale at merchant site 104 (Step 410). That is, the engine 360 determines what products are available for purchase at merchant site 104. Product information may take any form, such as descriptions of each product, serial numbers or other unique identifiers corresponding to entries in a product database (where the database may reside on merchant site server 222, prediction server 218, or any other location accessible by prediction server 218), and the like. Any such electronic information capable of identifying products for comparison to a user profile may be employed.

Next, the prediction and recommendation engine 360 retrieves a profile of the particular device 102, i.e. the particular user 100, that is headed to merchant site 104 (Step 420). Profiles are retrieved from user profile storage 370 if they are stored locally on prediction server 218, or from some other user profile source 214. User profiles may include any information for determining likely future purchases. For example, the user profiles may be electronic profiles containing identity information of the corresponding user 100 and his or her purchase history, e.g., a list of past products purchased by user 100. The identity information may be an identity or unique identifier of the person, i.e. name, phone number or the like, and may also include a unique identifier of the device 102, such as a uniform resource locator (URL). The profile may also include information corresponding to when the products were purchased, and perhaps even price. As another example, user profiles may include information corresponding to items frequently searched by the user 100. This may be, for instance, a list of search terms corresponding to products, and when or how often the terms are entered.

User profiles are known, and embodiments of the disclosure may employ any type of user profile. Further, these profiles may be compiled in any manner. For instance, the prediction and recommendation engine 360 may determine user purchases at merchant site 104 or any other site the engine 360 has access to. These purchases may be recorded to provide a purchase history of the user. Another service may also compile this history and make it available to engine 360. As another example, another computer or service, such as user profile source 214, may record products the user has searched for or examined online, which may indicate products desired by the user. As a further example, the profile may be compiled at least partly using data collected from the environment of the user. In this example, sensors within the environment of the user, such as internet of things (IoT) sensors, may exist in proximity to the user, and may collect information on products used or worn by the user. For instance, voice-operated personal assistants may log voice-operated searches for products. Environmental information collected by such sensors may also be used to infer products that may soon be required by the user 100. For instance, detection of a broken appliance may imply that the user 100 requires a replacement, whereupon that appliance may be placed in the user profile. The products within which the IoT sensors may be located may also be placed in the user profile. Alternatively, detection of approaching inclement weather may result in placement of, e.g., raingear in a user profile, and detection that the user has run out of certain groceries or other products may result in placement of those products in the profile. User profiles may include product information gathered and determined by any such IoT sensors, in any manner.

The comparison module 375 then compares the retrieved product identifiers to the user profile (step 430), to determine matches therebetween (Step 440). Matches are the subset of product identifiers whose products match the user profile. Any comparison method may be employed. When the user profile includes a list of items, comparison may be made by simply comparing the items on the profile to items offered by merchant site 104 that were retrieved in Step 410. The comparison module 375 may determine matches as simply any items that are common to both lists, i.e. any item that is both offered for sale at merchant site 104 and listed in the profile of user 100.

The comparison module 375 may also examine the user profiles in other ways, to determine matches. In one such example, the comparison module 375 may determine that certain items are purchased at regular intervals. When the extrapolated time for another purchase of those items is near or has passed, and the profile indicates that the item has not yet been purchased again, the comparison module 375 may look for a matching item on the list of products available at the merchant site 104. Additionally, the comparison module 375 may sort the profile by product type, to determine which product types are likely to be purchased by the user 100. Products offered at merchant site 104 that are of that same type are then considered to be matches. For instance, comparison module 375 may be programmed with a set of product types and a mapping of products to these various types, so that user profile products are each mapped to a product type. Types that contain products may be deemed types that the user 100 is interested in, and merchant site 104 products of that same type may be considered matches.

Alternatively, product types for which the user 100 has not made any purchases within a predetermined time, or types for which the user 100 purchases products at regular intervals and may thus purchase again soon, can also be considered as desired by user 100. Merchant site 104 products of these same types may thus be considered matches. Embodiments of the disclosure include comparison of merchant site 104 products to user profile products in any manner.

If no matches are found, the process returns to Step 400. That is, if no matching products can be found, the user 100 likely does not desire any particular item from merchant site 104, e.g., he or she may simply intend to browse the site 104. However, if one or more matching products are determined, the order transmission module 380 transmits identifiers of the matching products to merchant site 104 as a customer order to be fulfilled (Step 450). The transmitted identifiers may act as instructions to fulfill an order comprising the products corresponding to the identifiers, or a separate instruction may be provided. An identifier of the device 102 or user 100 may also optionally be transmitted. In particular, the identifiers of matching products are transmitted to an order fulfillment operation of merchant site 104, which may be any portion of merchant site 104 for taking product orders. The order fulfillment operation may thus be a computer terminal located anywhere in merchant site 104 and in communication with merchant site server 222 or prediction server 218 so as to receive customer orders therefrom. The order fulfillment operation may also be merchant site server 222 if server 222 is located at merchant site 104, and may also be a telephone or other device for receiving calls if merchant site server 222 or prediction server 218 is programmed to transmit product orders audibly. The prediction server 218 may transmit an identifier of the user 100 along with the order, so that the order can be designated or marked for that particular customer.

The merchant site 104 then fulfills the received customer order by retrieving the products of the order from inventory and collecting them together as a completed order for the customer, i.e. user 100, to pick up (Step 460). If the prediction server 218 also transmits an identifier of the device 102 or user 100 as above, this identifier can be associated with the completed order, so as to be more readily recognizable by the merchant site 104 staff or the user 100. The completed order is then offered to the user 100 when he or she enters the merchant site 104 (Step 470). In this manner, products likely to be desired by the user 100 are ready for users as soon as they enter site 104, eliminating the need for any additional shopping.

The foregoing description, for purposes of explanation, used specific nomenclature to provide a thorough understanding of the disclosure. However, it will be apparent to one skilled in the art that the specific details are not required to practice the methods and systems of the disclosure. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, merchant site products can be compared to any type of consumer profile, in any manner, to determine matching products that the consumer is likely to be interested in. The embodiments were chosen and described in order to best explain the principles of the invention and its practical applications, to thereby enable others skilled in the art to best utilize the methods and systems of the disclosure and various embodiments with various modifications as are suited to the particular use contemplated. Additionally, different features of the various embodiments, disclosed or otherwise, can be mixed and matched or otherwise combined so as to create further embodiments contemplated by the disclosure.

1. A method for automated product procurement, the method comprising:
predicting an impending transaction according to an electronic device having a device identifier;
retrieving electronic identifiers corresponding to products offered for sale;
retrieving an electronic profile corresponding to the device identifier;
comparing the electronic identifiers to the electronic profile to determine a subset of the electronic identifiers;
transmitting the subset of the electronic identifiers to a fulfillment operation;
responsive to the transmitted subset of the electronic identifiers, collecting the products corresponding to the transmitted subset of the electronic identifiers at the fulfillment operation so as to form a completed order; and
offering the completed order for purchase.

2. The method of claim 1, wherein the predicting further comprises receiving an address entered into the electronic device, and determining that the address corresponds to a merchant site, so as to thereby determine that the electronic device is likely traveling to the merchant site.

3. The method of claim 1, wherein the predicting further comprises:
tracking a movement of the electronic device; and
determining, from the movement, that the electronic device is traveling to a merchant site.

4. The method of claim 1, wherein the predicting further comprises receiving search terms entered into the electronic device.

5. The method of claim 1, further comprising:
retrieving, from the electronic profile, an identity corresponding to the electronic device; and
associating the completed order with the identity.

6. The method of claim 1, wherein the electronic profile includes information retrieved from one or more internet of things (IoT) sensors.

7. The method of claim 1, wherein the products corresponding to the transmitted subset of the electronic identifiers are products that are both offered for sale at a merchant site and listed in the electronic profile.

8. The method of claim 1:
wherein the comparing further comprises determining types of products likely to be purchased according to the electronic profile; and
wherein the products that are likely to be purchased are products that are offered for sale at a merchant site and that are of the determined types.

9. The method of claim 1, wherein the electronic profile comprises a purchase history corresponding to the electronic device.

10. The method of claim 1, wherein the electronic profile comprises information corresponding to frequently searched items.

11. The method of claim 1:
wherein the collecting further comprises collecting the determined products at the fulfillment operation before the electronic device arrives at the fulfillment operation; and
wherein the offering further comprises offering the completed order for purchase upon arrival by the electronic device at the fulfillment operation.

12. A system for automated product procurement, the system comprising:
a storage device; and
control circuitry configured to:
predict an impending transaction according to an electronic device having a device identifier;
retrieve electronic identifiers corresponding to products offered for sale;
retrieve an electronic profile corresponding to the device identifier;
compare the electronic identifiers to the electronic profile to determine a subset of the electronic identifiers;
transmit the subset of the electronic identifiers to a fulfillment operation; and
instruct the fulfillment operation to collect the products corresponding to the transmitted subset of the electronic identifiers so as to form a completed order for purchase.

13. The system of claim 12, wherein the predicting further comprises receiving an address entered into the electronic device, and determining that the address corresponds to a merchant site, so as to thereby determine that the electronic device is likely traveling to the merchant site.

14. The system of claim 12, wherein the predicting further comprises:
tracking a movement of the electronic device; and
determining, from the movement, that the electronic device is traveling to a merchant site.

15. The system of claim 12, wherein the predicting further comprises receiving search terms entered into the electronic device.

16. The system of claim 12, further comprising:
retrieving, from the electronic profile, an identity corresponding to the electronic device; and
associating the completed order with the identity.

17. The system of claim 12, wherein the electronic profile includes information retrieved from one or more internet of things (IoT) sensors.

18. The system of claim 12, wherein the products corresponding to the transmitted subset of the electronic identifiers are products that are both offered for sale at a merchant site and listed in the electronic profile.

19. The system of claim 12:
wherein the comparing further comprises determining types of products likely to be purchased according to the electronic profile; and
wherein the products that are likely to be purchased are products that are offered for sale at a merchant site and that are of the determined types.

20. The system of claim 12, wherein the electronic profile comprises a purchase history corresponding to the electronic device.

21.-33. (canceled)
